(19) United States
(12) Patent Application Publication
(10) Pub. No.: US 2021/0280149 A1
(43) Pub. Date: Sep. 9, 2021

(54) VEHICLE-MOUNTED APPARATUS CONNECTED TO INFORMATION TERMINAL AND VEHICLE MOUNTED SYSTEM

(71) Applicant: Panasonic Intellectual Property Management Co., Ltd., Osaka (JP)

(72) Inventors: Hideki TANAKA, Kanagawa (JP); Hiroyasu MENO, Kanagawa (JP); Tomohiro UKAI, Tokyo (JP); Nobuyuki TANIGAWA, Kanagawa (JP); Toshiaki IKEMATSU, Kanagawa (JP)

(73) Assignee: Panasonic Intellectual Property Management Co., Ltd., Osaka (JP)

(21) Appl. No.: 17/191,231

(22) Filed: Mar. 3, 2021

(30) Foreign Application Priority Data
Mar. 4, 2020 (JP) 2020-036392

(51) Int. Cl. G09G 5/00; B60K 35/00; G07C 5/02; G06F 3/0484; G06F 3/14

(52) U.S. Cl. CPC G09G 5/006; B60K 35/00; G07C 5/02; G06F 3/0484; G05D 1/0061; B60K 2370/175; B60K 2370/52; B60K 2370/73; G06F 3/14

(57) ABSTRACT

A content acquisition interface acquires a content. An information acquisition interface acquires traveling condition information on a vehicle. A control interface causes a display interface to display the content when the traveling condition information acquired by the information acquisition interface indicates an automatic driving level equal to or higher than a threshold value or causes the display interface to display information on traveling-based restriction when the traveling condition information acquired by the information acquisition interface does not indicate an automatic driving level equal to or higher than the threshold value.

### BACKGROUND

### 1. Field

The present disclosure relates to connection technology and, more particularly, to a vehicle-mounted apparatus connected to an information terminal and a vehicle-mounted system.

### 2. Description of the Related Art

In a vehicle-mounted apparatus, various content including videos, images, sound, characters, etc. are provided. Display of content is frequently updated, and so it is necessary to restrict updates in order to secure the safety of passengers while the vehicle is traveling. For this reason, content processed based on a predetermined restriction rule are displayed in accordance with the traveling condition information (see, for example, patent literature 1).
[Patent literature 1] WO14/080952

Improvement of user convenience is called for even in a case in which the vehicle-mounted apparatus imposes traveling-based restriction in accordance with the traveling condition information on the vehicle.

### SUMMARY

The present disclosure addresses the above-described issue, and a general purpose thereof is to provide a technology for improving user convenience even in a case of imposing traveling-based restriction in accordance with the traveling condition information on the vehicle.

A vehicle-mounted apparatus adapted to be mounted on a vehicle, including: a content acquisition interface that acquires a content; a display interface capable of displaying the content acquired by the content acquisition interface; an information acquisition interface that acquires traveling condition information on the vehicle; and a control interface that causes the display interface to display the content when the traveling condition information acquired by the information acquisition interface indicates an automatic driving level equal to or higher than a threshold value or causes the display interface to display information on traveling-based restriction when the traveling condition information acquired by the information acquisition interface does not indicate an automatic driving level equal to or higher than the threshold value.

Another embodiment of the present disclosure also relates to a vehicle-mounted apparatus. The apparatus is a vehicle-mounted apparatus adapted to be mounted on a vehicle, including: a content acquisition interface that acquires a content; a display interface capable of displaying the content acquired by the content acquisition interface; an information acquisition interface that acquires traveling condition information on the vehicle; and a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling. When the control interface receives an instruction to display the content, the control interface causes the display interface to display, before the content is displayed, a notice to indicate that the information on traveling-based restriction will be displayed when the vehicle is driven, even if the traveling condition information acquired by the information acquisition interface does not indicate that the vehicle is traveling.

Another embodiment of the present disclosure relates to a vehicle-mounted system. The vehicle-mounted system includes: a vehicle-mounted apparatus adapted to be mounted on a vehicle; and an information terminal capable of communicating with the vehicle-mounted apparatus. The vehicle-mounted apparatus includes: a content acquisition interface that acquires a content executed in the information terminal; a display interface capable of displaying the content acquired by the content acquisition interface; an information acquisition interface that acquires traveling condition information on the vehicle; and a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling. When the traveling condition information acquired by the information acquisition interface indicates that the vehicle is traveling, the control interface notifies the information terminal that the vehicle is traveling, and, when notified by the vehicle-mounted apparatus that the vehicle is traveling, the information terminal disables user operation.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 shows a structure of the vehicle interior of a vehicle according to embodiment 1;

FIG. 2 shows a configuration of the vehicle-mounted apparatus mounted on the vehicle of FIG. 1 and a configuration of the information terminal and the server;

FIGS. 3A-3B show screens displayed on the display interface of FIG. 2;

FIG. 4 shows a data structure of the table stored in the storage interface of FIG. 2;

FIG. 5 is a flowchart showing a sequence of steps performed by the vehicle-mounted apparatus of FIG. 2;

FIGS. 6A-6B show screens displayed on the display interface according to embodiment 2;

FIG. 7 is a flowchart showing a sequence of steps performed by the vehicle-mounted apparatus according to embodiment 2;

FIG. 8 is a sequence chart showing a sequence of steps performed by the vehicle-mounted apparatus and the information terminal according to embodiment 3; and

FIG. 9 shows a screen displayed on the display interface according to embodiment 4.

### DETAILED DESCRIPTION

The invention will now be described by reference to the preferred embodiments. This does not intend to limit the scope of the present invention, but to exemplify the invention.

### Embodiment 1

A brief summary will be given before describing the present disclosure in specific details. Embodiment 1 of the present disclosure relates to a vehicle-mounted system including a vehicle-mounted apparatus mounted on a vehicle and an information terminal connected to the vehicle-mounted apparatus. An example of the vehicle-mounted apparatus is an electronic device such as a navigation apparatus, and an example of the information terminal is a smartphone. For example, the vehicle-mounted apparatus executes a navigation function and displays route guidance on a monitor along with map information. Various applications are installed in the information terminal, and the information terminal displays a screen showing the result of executing the application on the monitor. In such a vehicle-mounted system, images of the content played back in the information terminal are displayed on the monitor of the vehicle-mounted apparatus. In the related art, images of the content are displayed when the vehicle is not traveling, and a screen indicating that traveling-based restriction is imposed is displayed instead of images of the content. When the vehicle has capabilities for automatic driving, and automatic driving of a high level (e.g., level 5) is being executed, it is preferable to display content images even if the vehicle is traveling in order to improve user convenience. This is addressed by the vehicle-mounted apparatus according to the embodiment by checking the level of automatic driving. When the level of automatic driving is equal to or higher than a threshold value, content images are displayed. When the level of automatic driving is not equal to or higher than the threshold value, information on traveling-based restriction is displayed.

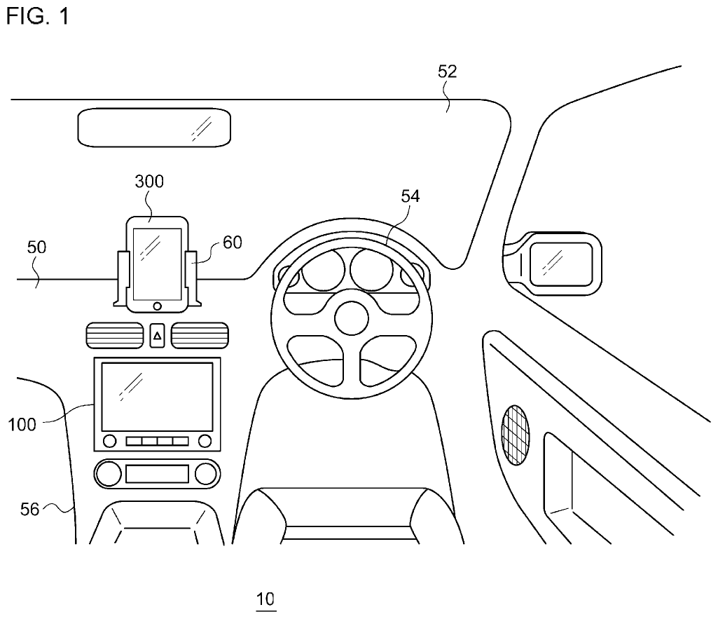

FIG. 1 shows a structure of the vehicle interior of a vehicle 10. A windshield 52 is provided in front of a dashboard 50 provided frontward in the vehicle interior. A steering wheel 54 is provided to the right of the dashboard 50. Alternatively, the steering wheel 54 may be provided to the left of the dashboard 50. A center console 56 extending vertically is provided at the central portion of the dashboard 50. A vehicle-mounted apparatus 100 is set within the center console 56. A mounting table 60 is provided above the center console 56. The mounting table 60 supports an information terminal 300. The information terminal 300 may be held by the user. The information terminal 300 and the vehicle-mounted apparatus 100 can be connected wirelessly or by wire.

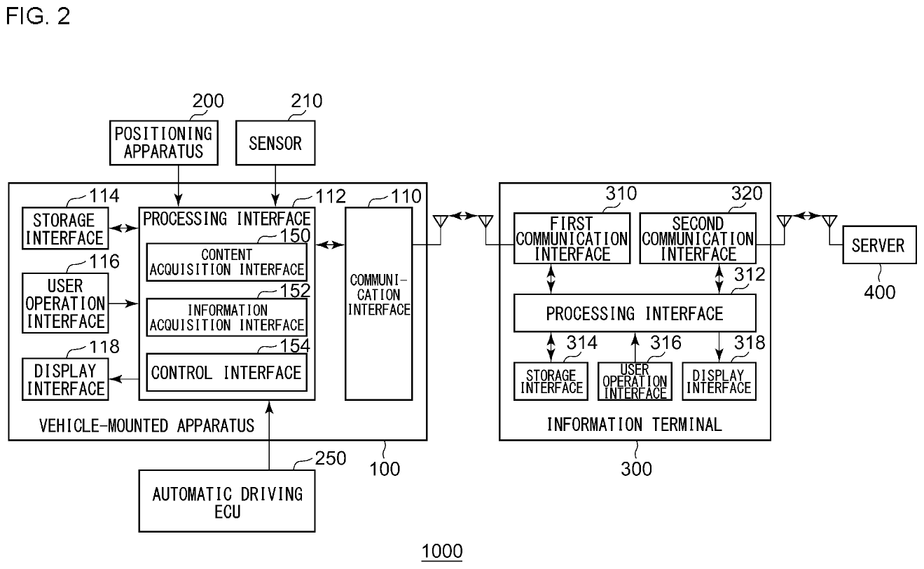

FIG. 2 shows a configuration of the vehicle-mounted apparatus 100 mounted on the vehicle 10 and a configuration of the information terminal 300 and a server 400. The vehicle-mounted apparatus 100 can be connected to a positioning apparatus 200, a sensor 210, and an automatic driving electronic control unit (ECU) 250 and includes a communication interface 110, a processing interface 112, a storage interface 114, a user operation interface 116, and a display interface 118. The processing interface 112 includes a content acquisition interface 150, an information acquisition interface 152, and a control interface 154. The information terminal 300 includes a first communication interface 310, a processing interface 312, a storage interface 314, a user operation interface 316, a display interface 318, and a second communication interface 320.

As described above, the vehicle-mounted apparatus 100 is a navigation apparatus, etc. and is mounted on the vehicle 10. The positioning apparatus 200 connected to the vehicle-mounted apparatus 100 measures the position of the vehicle 10 based on a signal from a satellite of a global navigation satellite system (GPSS) and outputs measured positional information to the vehicle-mounted apparatus 100. Further, the sensor 210 connected to the vehicle-mounted apparatus 100 detects the speed of the vehicle 10 and outputs the detected result (hereinafter “detection result”) to the vehicle-mounted apparatus 100. A publicly known technology may be used for this, and a description thereof is omitted. The automatic driving ECU 250 is a control apparatus for executing automatic driving of the vehicle 10. A publicly known technology may be used for automatic driving, and a description thereof is omitted.

Generally, the level of automatic driving is categorized into “0” through “5”. Level “0” means that driving is not automated, and the driver executes all dynamic driving tasks. Level “1” means driving support. The system executes subtasks for vehicle movement control either in the longitudinal direction or in the lateral direction in a limited region. Level “2” means partial driving automation. The system executes subtasks for vehicle movement control both in the longitudinal direction and in the lateral direction in a limited region. Level “3” means conditional driving automation. The system executes all dynamic driving tasks in a limited region and suitably responds to a request for system interruption in the event that it is difficult to continue the task. Level “4” means advanced driving automation. The system executes all dynamic driving tasks and responds to an event in which it is difficult to continue the task in a limited region. Level “5” means full driving automation. The system executes all dynamic driving tasks and responds to an event in which it is difficult to continue the task unlimitedly.

The communication interface 110 executes communication wirelessly or by wire. The communication interface 110 can be connected to the information terminal 300. The wireless communication function of the communication interface 110 is compatible with, for example, Bluetooth (registered trademark) or wireless local area network (LAN). An application program (hereinafter, “application”) is stored in the storage interface 114. For example, the application may be an application capable of executing the navigation function or an application capable of executing the function of playing back content such as music and video. The storage interface 114 may store information other than the application. The user operation interface 116 is an interface manipulated by the user and is exemplified by a button. Alternatively, the user operation interface 116 may be integrated with the display interface 118 described later and configured as a touch panel. The user operation interface 116 receives an instruction from the user and outputs the received instruction to the processing interface 112. The display interface 118 is a monitor and displays videos, images, and messages output from the processing interface 112.

In this configuration, when the processing interface 112 receives the instruction from the user operation interface 116, the processing interface 112 executes the application stored in the storage interface 114 and outputs the result on the display interface 118. In the case the application is capable of executing the navigation function, the processing interface 112 displays a screen for route guidance, etc. on the display interface 118 by executing the application. For route guidance, the positional information from the positioning apparatus 200 and the detection result from the sensor 210 are used. Further, in the case the application is capable of executing the function of playing back videos, the processing interface 112 displays the video that is played back on the display interface 118 by executing the application. Further, in the case the application is capable of executing the function of playing back music, the processing interface 112 outputs the music that is played back from a speaker (not shown) by executing the application. For execution of these applications, a publicly known technology may be used, and a description thereof is omitted.

As described above, the information terminal 300 is a smartphone, etc. The first communication interface 310 is compatible with the communication scheme commonly used in the communication interface 110 of the vehicle-mounted apparatus 100 and is capable of communicating with the communication interface 110. The second communication interface 320 executed wireless communication. The wireless communication function of the second communication interface 320 is compatible with, for example, long term evolution (LTE) or metropolitan area network (MAN). The communication scheme that the second communication interface 320 is compatible with enables communication over a longer distance than the communication scheme that the first communication interface 310 is compatible with. The second communication interface 320 can communicate with the server 400.

An application program (hereinafter, “application”) is stored in the storage interface 314. For example, the application is a player application for playing back videos, etc. or an electronic mail application. The storage interface 314 may store information other than the application.

The user operation interface 316 is an interface manipulated by the user and is exemplified by a button. Alternatively, the user operation interface 316 may be integrated with the display interface 318 described later and configured as a touch panel. The user operation interface 316 receives an instruction from the user and outputs the received instruction to the processing interface 312. When the processing interface 312 receives the instruction from the user operation interface 316, the processing interface 312 executes the application stored in the storage interface 314 and outputs the result on the display interface 318. The display interface 318 is a monitor and displays videos, images, and messages output from the processing interface 312. The server 400 establishes a connection with the information terminal 300 via a network (not shown) and executes a process coordinated with the application executed in the information terminal 300.

A description will now be given of a process whereby the display interface 118 of the vehicle-mounted apparatus 100 displays content in this configuration. An example of content is video. When the vehicle-mounted apparatus 100 and the information terminal 300 are started in the vehicle 10, the communication interface 110 of the vehicle-mounted apparatus 100 establishes a connection with the first communication interface 310 of the information terminal 300. A publicly known technology may be used for connection between the communication interface 110 and the first communication interface 310, and a description thereof is omitted.

When the user selects a content by manipulating the user operation interface 316 of the information terminal 300, the processing interface 312 generates a request signal for requesting playback of the content. The second communication interface 320 transmits the request signal to the server 400. Upon receiving the request signal, the server 400 plays back the content designated by the request signal and transmits the playback signal to the information terminal 300. The second communication interface 320 of the information terminal 300 receives the content played back. The processing interface 312 causes the first communication interface 310 to transmit the content received by the second communication interface 320 to the vehicle-mounted apparatus 100.

Upon receiving the content from the information terminal 300, the communication interface 110 of the vehicle-mounted apparatus 100 outputs the content to the processing interface 112. The content acquisition interface 150 of the processing interface 112 acquires the content. In the case the sensor 210 detects the traveling speed of the vehicle 10, the sensor 210 outputs the value of the detected traveling speed to the processing interface 112. Further, the automatic driving ECU 250 outputs the value of the automatic driving level to the processing interface 112. The value of the automatic driving level may vary depending on the situation. The information acquisition interface 152 acquires, as the traveling condition information on the vehicle 10, the value of the traveling speed from the sensor 210 and the value of the automatic driving level from the automatic driving ECU 250.

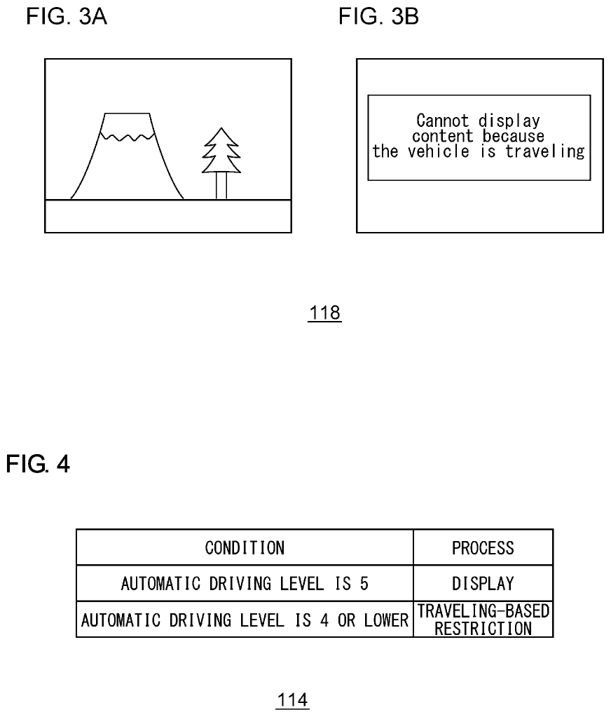

When the value of the traveling speed acquired by the information acquisition interface 152 is smaller than a predetermined value, the control interface 154 determines that the vehicle 10 is at a stop and causes the display interface 118 to display the content acquired by the content acquisition interface 150. FIGS. 3A-3B show screens displayed on the display interface 118. As shown in FIG. 3A, the display interface 118 displays a video of the content when the vehicle 10 is at a stop. FIG. 3B will be described later, and reference is made back to FIG. 2.

When the value of the traveling speed acquired by the information acquisition interface 152 is equal to or larger than the predetermined value, the control interface 154 determines that the vehicle 10 is traveling. When determining that the vehicle 10 is traveling, the control interface 154 determines the processing detail based on a table stored in the storage interface 114 and the value of the automatic driving level. FIG. 4 shows a data structure of the table stored in the storage interface 114. When the automatic driving level is “5”, the control interface 154 determines to display the content. When the automatic driving level is “4” or lower, the control interface 154 determines to impose traveling-based restriction. Stated otherwise, the control interface 154 causes the display interface 118 to display the content when the automatic driving level is equal to higher than a threshold value and causes the display interface 118 to display the information on traveling-based restriction when the automatic driving level is not equal to or higher than the threshold value. In the aforementioned example, the threshold value is defined to be “5”, but the embodiment is non-limiting as to the threshold value. The threshold value may be defined by using the user operation interface 116. Reference is made back to FIG. 2.

When the control interface 154 determines to display the content, the display interface 118 displays the screen shown in FIG. 3A. When the control interface 154 determines to impose traveling-based restriction, on the other hand, the display interface 118 displays the screen shown in FIG. 3B. As illustrated, a message “Cannot display content because the vehicle is traveling” is displayed as information on traveling-based restriction.

The content stored in the server 400 is described above as being played back by the server 400, and the content played back is described as being displayed on the display interface 118 of the vehicle-mounted apparatus 100 via the information terminal 300. However, the mode of playing back the content is not limited to the one described above. For example, the content stored in the information terminal 300 may be played back by the information terminal 300, and the content played back may be displayed on the display interface 118 of the vehicle-mounted apparatus 100. Alternatively, the content in the vehicle-mounted apparatus 100 may be played back by the vehicle-mounted apparatus 100, and the content played back may be displayed on the display interface 118. In this case, the vehicle-mounted apparatus 100 and the information terminal 300 may not be connected.

The features are implemented in hardware such as a central processing unit (CPU), a memory, or other large scale integration (LSI), of any computer and in software such as a program loaded into a memory. The figure depicts functional blocks implemented by the cooperation of these elements. Therefore, it will be understood by those skilled in the art that the functional blocks may be implemented in a variety of manners by hardware only or by a combination of hardware and software.

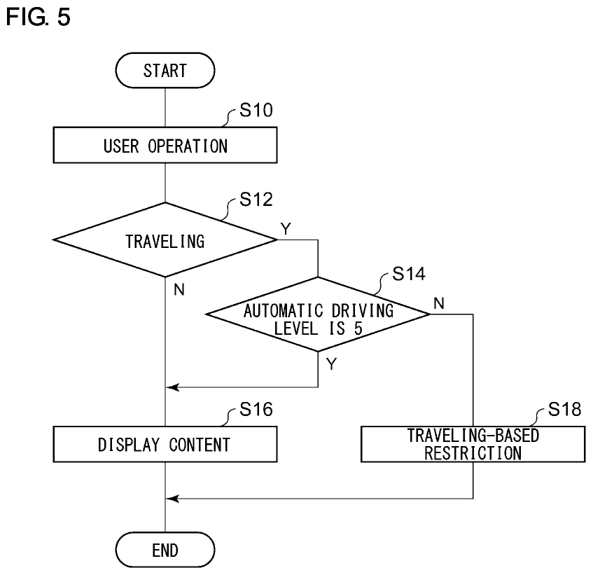

A description will now be given of the operation of the vehicle-mounted apparatus100 having the configuration described above. FIG. 5 is a flowchart showing a sequence of steps performed by the vehicle-mounted apparatus 100. The processing interface 112 receives a use operation (S10). When the vehicle is traveling (Y in S12) and the automatic driving level is “5” (Y in S14), the display interface 118 displays the content (S16). When the vehicle is not traveling (N in S12), the display interface 118 displays the content (S16). When the automatic driving level is not “5” (N in S14), the display interface 118 displays the information on traveling-based restriction (S18).

According to this embodiment, the content is displayed when the automatic driving level is equal to or higher than a threshold value, even if the vehicle is traveling. Accordingly, user convenience is improved even in a case of imposing traveling-based restriction in accordance with the traveling condition information on the vehicle. Further, the information on traveling-based restriction is displayed even if the vehicle is traveling, unless the automatic driving level is equal to or higher than the threshold value.

### Embodiment 2

A description will now be given of embodiment 2. Like embodiment 1, embodiment 2 relates to a vehicle-mounted system including a vehicle-mounted apparatus mounted on a vehicle and an information terminal connected to the vehicle-mounted apparatus. In embodiment 1, it is assumed that the vehicle 10 is capable of executing automatic driving. Meanwhile, embodiment 2 relates to a case in which the vehicle 10 is not automatically driven. The vehicle-mounted apparatus 100, the information terminal 300, and the server 400 according to embodiment 2 are of the same type as that of FIG. 2, but the system may not include the automatic driving ECU 250. The description below highlights a difference from embodiment 1.

When the user selects a content by manipulating the user operation interface 316 of the information terminal 300, the processing interface 312 generates a request signal for requesting playback of the content. The second communication interface 320 transmits the request signal to the server 400. Upon receiving the request signal, the server 400 plays back the content designated by the request signal and transmits the playback signal to the information terminal 300. The second communication interface 320 of the information terminal 300 receives the content played back. The processing interface 312 causes the first communication interface 310 to transmit the content received by the second communication interface 320 to the vehicle-mounted apparatus 100.

Upon receiving the content from the information terminal 300, the communication interface 110 of the vehicle-mounted apparatus 100 outputs the content to the processing interface 112. The content acquisition interface 150 of the processing interface 112 acquires the content. In the case the sensor 210 detects the traveling speed of the vehicle 10, the sensor 210 outputs the value of the traveling speed to the processing interface 112. The information acquisition interface 152 acquires, as the traveling condition information on the vehicle 10, the value of the traveling speed from the sensor 210.

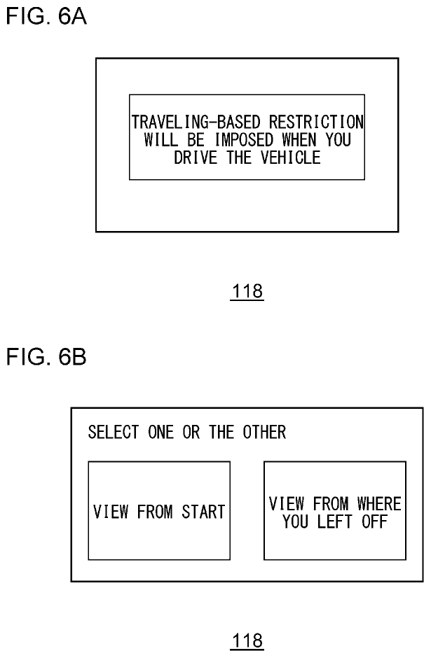

When the value of the traveling speed acquired by the information acquisition interface 152 is smaller than a predetermined value, the control interface 154 determines that the vehicle 10 is at a stop. When the value of the traveling speed acquired by the information acquisition interface 152 is equal to or larger than the predetermined value, the control interface 154 determines that the vehicle 10 is traveling. Regardless of whether the determination result indicates that the vehicle is traveling or not, the control interface 154 causes the display interface 118 to display an advance notice. An advance notice is a notice to indicate that the information on traveling-based restriction will be displayed when the vehicle is driven. FIGS. 6A-6B show screens displayed on the display interface 118. As shown in FIG. 6A, a message “Traveling-based restriction will be imposed when you drive the vehicle” is displayed as an advance notice. FIG. 6B will be described later, and reference is made back to FIG. 2.

Following this, the control interface 154 causes, when the control interface 154 has determined that the vehicle 10 is at a stop, the display interface 118 to display the content acquired by the content acquisition interface 150. In that process, the screen displayed on the display interface 118 is as shown in FIG. 3A. When the control interface 154 determines that the vehicle 10 is traveling, the control interface 154 causes the display interface 118 to display the information on traveling-based restriction. In that process, the screen displayed on the display interface 118 is as shown in FIG. 3B. In other words, the control interface 154 receiving an instruction to display a content causes the display interface 118 to display, before the content is displayed, a notice to indicate that the information on traveling-based restriction will be displayed when the vehicle is driven, even if the traveling condition information acquired by the information acquisition interface 152 does not indicate traveling.

As in embodiment 1, the content stored in the server 400 is played back by the server 400, and the content played back is displayed on the display interface 118 of the vehicle-mounted apparatus 100 via the information terminal 300. However, the mode of playing back content is not limited to the one described above. For example, the content stored in the information terminal 300 may be played back by the information terminal 300, and the content played back may be displayed on the display interface 118 of the vehicle-mounted apparatus 100. Alternatively, the content in the vehicle-mounted apparatus 100 may be played back by the vehicle-mounted apparatus 100, and the content played back may be displayed on the display interface 118. In this case, the vehicle-mounted apparatus 100 and the information terminal 300 may not be connected. Further, the user may manipulate the user operation interface 116 of the vehicle-mounted apparatus 100 to select a content.

It will be assumed below that the vehicle 10 makes a transition from a stopped state to a traveling state and then returns to a stopped state. This is equivalent to a case in which the system makes a transition from a state in which the display interface 118 displays the content to a state in which the display interface 118 displays the traveling-based restriction and returns to a state in which the display interface 118 displays the content. In this case, the content is displayed partway and then the traveling-based restriction is displayed. When the traveling-based restriction is ended, the display of the content is resumed. When the display of the content is resumed, it is preferable to let the user select whether to view the content from the start or view the content from where it was suspended.

To address this, the processing interface 112 causes the display interface 118 to display a screen to allow the user to select whether to display the content from the start or display the content from where it was suspended, when, after the information on traveling-based restriction is displayed, the traveling condition information acquired by the information acquisition interface 152 no longer shows that the vehicle is traveling. The processing interface 112 causes this screen to be displayed at a point of time when the display on the display interface 118 switches from the content to the traveling-based restriction or at a point of time when the display on the display interface 118 switches from the traveling-based restriction to the content. FIG. 6B shows a screen to allow the user to select whether to display the content from the start or display the content from where it was suspended, when, after the information on traveling-based restriction is displayed, the traveling condition information acquired by the information acquisition interface 152 no longer shows that the vehicle is traveling. As illustrated, a message “Select one or the other”, a “View from start” button, and a “View from where you left off” button are displayed. In other words, the display interface 118 displays, after displaying the information on traveling-based restriction, a screen to allow the user to select whether to display the content from the start or display the content from where it was suspended, when the traveling condition information acquired by the information acquisition interface 152 no longer shows that the vehicle is traveling.

When the user selects the “View from the start” button or the “View from where you left off” button by manipulating the user operation interface 116, the processing interface 112 generates a playback instruction that includes the selection. When the “View from the start” button is selected, the playback instruction includes a request to play back the content from the start. When the “View from where you left off” button is selected, on the other hand, the playback instruction includes information on the time where the playback should be started. The communication interface 110 transmits the playback instruction to the information terminal 300. When the first communication interface 310 of the information terminal 300 receives the playback instruction, the second communication interface 320 transmits the playback request to the server 400. When the request to play back from the start is included in the playback instruction, the server 400 resumes the content by playing it back from the start. When the information on the time when the playback should be started is included in the playback request, the server 400 resumes the content by starting to play it back at the designated time. The subsequent steps are the same as described above, and a description thereof is omitted.

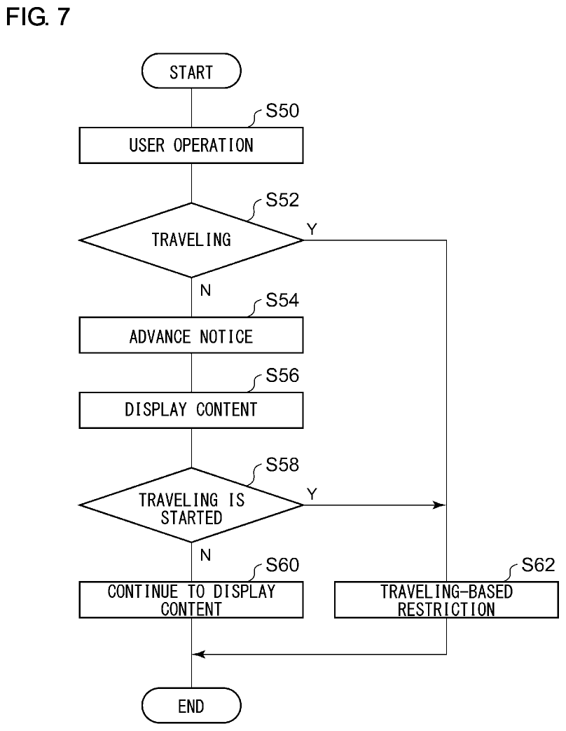

A description will now be given of the operation of the vehicle-mounted apparatus100 having the configuration described above. FIG. 7 is a flowchart showing a sequence of steps performed by the vehicle-mounted apparatus 100. The processing interface 112 receives a use operation (S50). When the vehicle is not traveling (N in S52), the display interface 118 displays an advance notice (S54) and then displays the content (S56). When traveling of the vehicle 10 is not started (N in S58), the display interface 118 continues to display the content (S60). When the vehicle is traveling (Y in S52) or when traveling of the vehicle 10 is started (Y in S58), the display interface 118 displays the information on traveling-based restriction (S62).

According to this embodiment, a notice is given, before the content is displayed, to indicate that the information on traveling-based restriction will be displayed when the vehicle is driven, even if the vehicle is not traveling. Accordingly, user convenience is improved even in a case of imposing traveling-based restriction in accordance with the traveling condition information on the vehicle. Further, a notice is given, before the content is displayed, to indicate that the information on traveling-based restriction will be displayed when the vehicle is driven, even if the vehicle is not traveling. Accordingly, it is possible to let the user know the condition and timing in which traveling-based restriction is initiated. Further, a screen to allow the user to select whether to display the content from the start or display the content from where it was suspended is displayed. Accordingly, the user can make a selection accordingly. Further, the user is allowed to select an action performed after the traveling-based restriction is lifted so that the user can continue to drive the vehicle comfortably after the traveling-based restriction is lifted.

### Embodiment 3

A description will now be given of embodiment 2. Like the foregoing embodiments, embodiment 3 relates to a vehicle-mounted system including a vehicle-mounted apparatus mounted on a vehicle and an information terminal connected to the vehicle-mounted apparatus. Embodiment 3 relates to the operation of the information terminal performed in the case the vehicle is traveling. The vehicle-mounted apparatus 100, the information terminal 300, and the server 400 according to embodiment 3 are of the same type as that of FIG. 2, but the system may not include the automatic driving ECU 250. The description below highlights a difference from the foregoing embodiment.

In the case the sensor 210 detects the traveling speed of the vehicle 10, the sensor 210 outputs the value of the detected traveling speed to the processing interface 112. The information acquisition interface 152 acquires, as the traveling condition information on the vehicle 10, the value of the traveling speed from the sensor 210. When the value of the traveling speed acquired by the information acquisition interface 152 is smaller than a predetermined value, the control interface 154 determines that the vehicle 10 is at a stop. When the value of the traveling speed acquired by the information acquisition interface 152 is equal to or larger than the predetermined value, the control interface 154 determines that the vehicle 10 is traveling.

When it is determined that the vehicle 10 is traveling, the processing interface 112 transmits a notification signal, which indicates that the vehicle 10 is traveling, to the information terminal 300 via the communication interface 110. Upon receiving the notification signal, the first communication interface 310 of the information terminal 300 outputs the notification signal to the processing interface 312. In this state, the processing interface 312 disables user operation in the user operation interface 316. In other words, the processing interface 312 does not accept the user operation even if the user manipulates the user operation interface 316. This is equivalent to prohibiting user operation in the information terminal 300 while the vehicle is traveling. Alternatively, user operation in the user operation interface 116 may be enabled. Further, the control interface 154 causes the display interface 118 to display the information on traveling-based restriction when it is determined that the vehicle 10 is traveling.

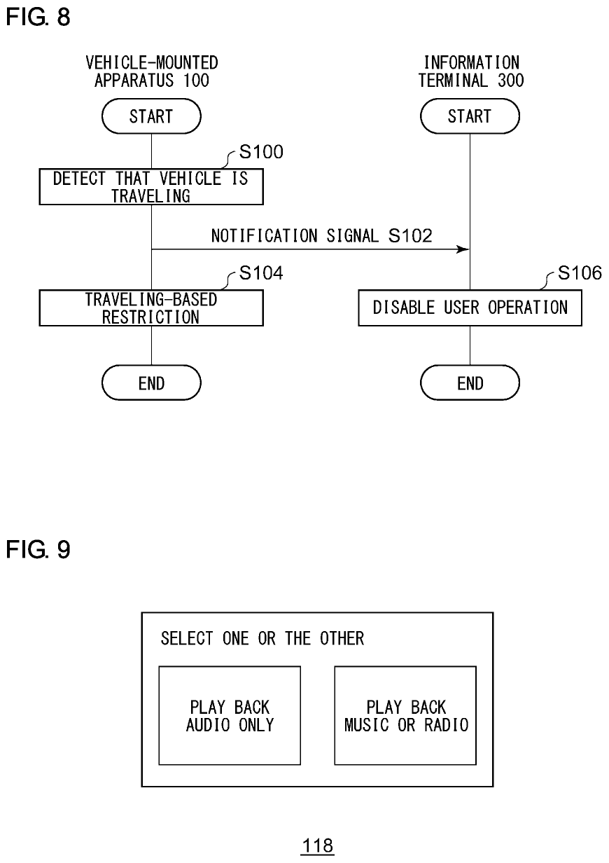

A description will now be given of the operation of the vehicle-mounted apparatus100 and the information terminal 300 having the configuration described above. FIG. 8 is a sequence chart showing a sequence of steps performed by the vehicle-mounted apparatus 100 and the information terminal 300. The vehicle-mounted apparatus 100 detects that the vehicle 10 is traveling (S100). The vehicle-mounted apparatus 100 transmits a notification signal to the information terminal 300 (S102). The vehicle-mounted apparatus 100 displays the information on traveling-based restriction (S104). The information terminal 300 disables user operation (S106).

According to this embodiment, user operation in the information terminal is disabled while the vehicle is traveling so that a traffic accident caused by manipulating the information terminal while the vehicle is being driven is prevented. Further, the information terminal disables user operation when notified by the vehicle-mounted apparatus that the vehicle is traveling. Accordingly, safety is improved.

### Embodiment 4

A description will now be given of embodiment 4. Like the foregoing embodiments, embodiment 4 relates to a vehicle-mounted system including a vehicle-mounted apparatus mounted on a vehicle and an information terminal connected to the vehicle-mounted apparatus. Embodiment 4 relates to the operation of the vehicle-mounted apparatus performed in the case the vehicle is traveling. The vehicle-mounted apparatus 100, the information terminal 300, and the server 400 according to embodiment 4 are of the same type as that of FIG. 2, but the system may not include the automatic driving ECU 250. The description below highlights a difference from the foregoing embodiment.

By manipulating the user operation interface 116 of the vehicle-mounted apparatus 100, the user can define the process performed in the vehicle-mounted apparatus 100 when the vehicle 10 at a stop, in which a content is being played back, is driven. When the user manipulates the user operation interface 116, the processing interface 112 causes the display interface 118 to display a user operation screen. FIG. 9 shows a screen displayed on the display interface 118. The screen is for user operation and shows a message “Please select one or the other”, a “Play back audio only” button, and a “Play back music or radio” button.

When the user manipulates the user operation interface 116 to select the “Play back audio only” button, the processing interface 112 plays back and outputs only the audio part of the content from a speaker (not shown). In other words, the video part of the content is not displayed on the display interface 118. When the user manipulates the user operation interface 116 to select the “Play back music or radio” button, on the other hand, the processing interface 112 plays back a content different from the content containing videos and comprised only of sound. The processing interface 112 outputs the content from the speaker. Alternatively, the processing interface 112 may plays the radio for output from the speaker.

According to this embodiment, the user is allowed to select the operation performed while traveling-based restriction is imposed. Accordingly, selection of traveling-based restriction desired by the user is allowed.

One embodiment of the present disclosure is summarized below. A vehicle-mounted apparatus according to an embodiment of the present disclosure is adapted to be mounted on a vehicle and includes: a content acquisition interface that acquires a content; a display interface capable of displaying the content acquired by the content acquisition interface; an information acquisition interface that acquires traveling condition information on the vehicle; and a control interface that causes the display interface to display the content when the traveling condition information acquired by the information acquisition interface indicates an automatic driving level equal to or higher than a threshold value or causes the display interface to display information on traveling-based restriction when the traveling condition information acquired by the information acquisition interface does not indicate an automatic driving level equal to or higher than the threshold value.

According to this embodiment, the content is displayed when the automatic driving level is equal to or higher than a threshold value, even if the vehicle is traveling. Accordingly, user convenience is improved even in a case of imposing traveling-based restriction in accordance with the traveling condition information on the vehicle.

Another embodiment of the present disclosure also relates to a vehicle-mounted apparatus. The apparatus is a vehicle-mounted apparatus adapted to be mounted on a vehicle, including: a content acquisition interface that acquires a content; a display interface capable of displaying the content acquired by the content acquisition interface; an information acquisition interface that acquires traveling condition information on the vehicle; and a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling. When the control interface receives an instruction to display the content, the control interface causes the display interface to display, before the content is displayed, a notice to indicate that the information on traveling-based restriction will be displayed when the vehicle is driven, even if the traveling condition information acquired by the information acquisition interface does not indicate that the vehicle is traveling.

According to this embodiment, a notice is given, before the content is displayed, to indicate that the information on traveling-based restriction will be displayed when the vehicle travels, even if the vehicle is not traveling. Accordingly, user convenience is improved even in a case of imposing traveling-based restriction in accordance with the traveling condition information on the vehicle.

When, after the information on traveling-based restriction is displayed, the traveling condition information acquired by the information acquisition interface no longer shows that the vehicle is traveling, the display interface may display a screen to allow a user to select whether to display the content from the start or display the content from where it was suspended. In this case, a screen to allow the user to select whether to display the content from the start or display the content from where it was suspended is displayed. Accordingly, the user can make a selection accordingly.

Another embodiment of the present disclosure relates to a vehicle-mounted system. The vehicle-mounted system includes: a vehicle-mounted apparatus adapted to be mounted on a vehicle; and an information terminal capable of communicating with the vehicle-mounted apparatus. The vehicle-mounted apparatus includes: a content acquisition interface that acquires a content executed in the information terminal; a display interface capable of displaying the content acquired by the content acquisition interface; an information acquisition interface that acquires traveling condition information on the vehicle; and a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling. When the traveling condition information acquired by the information acquisition interface indicates that the vehicle is traveling, the control interface notifies the information terminal that the vehicle is traveling, and, when notified by the vehicle-mounted apparatus that the vehicle is traveling, the information terminal disables user operation.

According to this embodiment, the information terminal disables user operation when the information terminal is notified by the vehicle-mounted apparatus that the vehicle is traveling. Accordingly, safety is improved.

When, after the information on traveling-based restriction is displayed, the traveling condition information acquired by the information acquisition interface no longer shows that the vehicle is traveling, the display interface may display a screen to allow a user to select whether to display the content from the start or display the content from where it was suspended. In this case, a screen to allow the user to select whether to display the content from the start or display the content from where it was suspended is displayed. Accordingly, the user can make a selection accordingly.

Described above is an explanation based on an exemplary embodiment. The embodiment is intended to be illustrative only and it will be understood by those skilled in the art that various modifications to constituting elements and processes could be developed and that such modifications are also within the scope of the present invention.

The information terminal 300 according to embodiments 1 through 4 may not display, for example, R-rated content on the display interface 118 and the display interface 318. In that process, the information terminal 300 selects the relevant content based on a pre-registered keyword or R-rating check. The same holds true of the vehicle-mounted apparatus 100. According to this variation, passengers (especially, minors) can be protected from hazardous content.

The vehicle-mounted apparatus 100 according to embodiment 4 may provide sound output of the superimpose while the vehicle 10 is traveling. According to this variation, the user is allowed to select an operation performed while traveling-based restriction is imposed. Accordingly, selection of traveling-based restriction desired by the user is allowed.

Arbitrary combinations of embodiments 1 through 4 are also useful. According to this variation, the advantages from the arbitrary combinations can be obtained.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2020-036392, filed on Mar. 4, 2020, the entire contents of which are incorporated herein by reference.

What is claimed is:

1. A vehicle-mounted apparatus adapted to be mounted on a vehicle, comprising:
a content acquisition interface that acquires a content;
a display interface capable of displaying the content acquired by the content acquisition interface;
an information acquisition interface that acquires traveling condition information on the vehicle; and
a control interface that causes the display interface to display the content when the traveling condition information acquired by the information acquisition interface indicates an automatic driving level equal to or higher than a threshold value or causes the display interface to display information on traveling-based restriction when the traveling condition information acquired by the information acquisition interface does not indicate an automatic driving level equal to or higher than the threshold value.

2. The vehicle-mounted apparatus according to claim 1, wherein
the content acquisition interface acquires the content executed in an information terminal apparatus through communication.

3. The vehicle-mounted apparatus according to claim 1, wherein
the traveling condition information acquired by the information acquisition interface includes a value of the automatic driving level from an automatic driving ECU.

4. A vehicle-mounted apparatus adapted to be mounted on a vehicle, comprising:
a content acquisition interface that acquires a content;
a display interface capable of displaying the content acquired by the content acquisition interface;
an information acquisition interface that acquires traveling condition information on the vehicle; and
a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling, wherein
when the control interface receives an instruction to display the content, the control interface causes the display interface to display, before the content is displayed, a notice to indicate that the information on traveling-based restriction will be displayed when the vehicle is driven, even if the traveling condition information acquired by the information acquisition interface does not indicate that the vehicle is traveling.

5. The vehicle-mounted apparatus according to claim 4, wherein
when, after the information on traveling-based restriction is displayed, the traveling condition information acquired by the information acquisition interface no longer shows that the vehicle is traveling, the display interface displays a screen to allow a user to select whether to display the content from the start or display the content from where it was suspended.

6. The vehicle-mounted apparatus according to claim 4, wherein
the content acquisition interface acquires the content executed in an information terminal apparatus through communication.

7. The vehicle-mounted apparatus according to claim 4, wherein
the traveling condition information acquired by the information acquisition interface includes a value of the automatic driving level from an automatic driving ECU.

8. A vehicle-mounted system comprising:
a vehicle-mounted apparatus adapted to be mounted on a vehicle; and
an information terminal capable of communicating with the vehicle-mounted apparatus, wherein
the vehicle-mounted apparatus includes:
a content acquisition interface that acquires a content executed in the information terminal;
a display interface capable of displaying the content acquired by the content acquisition interface;
an information acquisition interface that acquires traveling condition information on the vehicle; and
a control interface that causes the display interface to display the content when the traveling condition information acquired by the information acquisition interface does not indicate that the vehicle is traveling or causes the display interface to display information on traveling-based restriction when the traveling condition information acquired by the information acquisition interface indicates that the vehicle is traveling, wherein
when the traveling condition information acquired by the information acquisition interface indicates that the vehicle is traveling, the control interface notifies the information terminal that the vehicle is traveling, and
when notified by the vehicle-mounted apparatus that the vehicle is traveling, the information terminal disables user operation.

9. The vehicle-mounted system according to claim 8, wherein
when, after the information on traveling-based restriction is displayed, the traveling condition information acquired by the information acquisition interface no longer shows that the vehicle is traveling, the display interface displays a screen to allow a user to select whether to display the content from the start or display the content from where it was suspended.

10. The vehicle-mounted system according to claim 8, wherein
the traveling condition information acquired by the information acquisition interface includes a value of the automatic driving level from an automatic driving ECU.
